(19) United States
(12) Patent Application Publication
(10) Pub. No.: US 2011/0299834 A1
(43) Pub. Date: Dec. 8, 2011

(54) PROGRAM REVIEW ON ALTERNATE DISPLAY DEVICES

(75) Inventors: Kulvir S. Bhogal, Pflugerville, TX (US); Gregory J. Boss, Saginaw, MI (US); John J. Gontkof, III, Melbourne, FL (US); Rick A. Hamilton, II, Charlottesville, VA (US); Brian M. O'Connell, Research Triangle Park, NC (US)

(73) Assignee: International Business Machines Corporation, Armonk, NY (US)

(21) Appl. No.: 12/792,237

(22) Filed: Jun. 2, 2010

(51) Int. Cl. H04N 7/26; H04N 9/80

(52) U.S. Cl. 386/250

(57) ABSTRACT

A system and a method of recording a branch of a program being viewed on a primary viewing device coupled to a video recorder for playback of the branch on a secondary viewing device including the steps of creating a branch point in a program responsive to receiving a signal through an interface of the video recorder; recording a branch of the program from the branch point onward in the readable storage media; and sending the recorded branch to the secondary viewing device for viewing.

### BACKGROUND OF THE INVENTION

The present invention relates to digital video recorders, and more specifically to program review on an alternate display devices using a video recorder.

A digital video recorder (DVR) or personal video recorder (PVR) is a device that records video in a digital format to a disk drive or other medium. The term includes stand-alone set-top boxes and software for personal computers which enables video capture and playback to and from disk.

DVRs provide several viewing options, including: time shifting; pausing live television (TV); instant replay of interesting scenes of a program; chasing playback; and skipping advertising. Time shifting is the recording of a program to a storage medium to be viewed or listed at a time more convenient to the user. Chasing playback is a time shifting facility of personal video recorders and allows a user to simultaneously watch, stop or pause live television while continuing to record a program to its conclusion. Instant replay enables a user to quickly review recently rendered video. Pausing live television is a feature of PVRs that enables a user to stop the video and display a still frame. The user may reduce the size of the video being displayed at the point in which the video was paused.

Present technology limits viewing a recorded program on the television connected to the DVR and on another computational device such as a personal computer, cell phone, or handheld device at the same time. To rewind or replay a specific missed scene within a program being viewed on a primary display connected to the DVR interrupts the viewing of the program. This is an inconvenience if only a minority of users or one user missed an item of interest while other users in the room did not.

### SUMMARY OF THE INVENTION

According to one embodiment, a method of recording a branch of a program being viewed on a primary viewing device coupled to a video recorder for playback of the branch on a secondary viewing device including the steps of creating a branch point in a program is responsive to receiving a signal through an interface of the video recorder based on receiving an input from a user; recording a branch of the program from the branch point onward in the readable storage media; and sending the recorded branch to the secondary viewing device for viewing.

According to another embodiment of the present invention, a system for recording a branch of a program including a video recorder and a secondary viewing device. The video recorder has a readable storage media for storing a recorded branch of a program. The recorded branch is generated by creating a branch point in a program is responsive to receiving a signal through an interface of the video recorder based on receiving an input from a user and recording the branch of the program from the branch point onward into the readable storage media. The secondary viewing device is in communication with the video recorder for receiving the recorded branch of the program. The secondary viewing device displays the recorded branch to the user.

### BRIEF DESCRIPTION OF THE SEVERAL VIEWS OF THE DRAWINGS

FIG. 1 is a computer network in which illustrative embodiments may be implemented.

FIG. 2 is a data processing system in which illustrative embodiments may be implemented.

FIG. 3 shows a block diagram of a digital video recorder (DVR).

FIG. 4 shows the steps of setting a branch point.

### DETAILED DESCRIPTION OF THE INVENTION

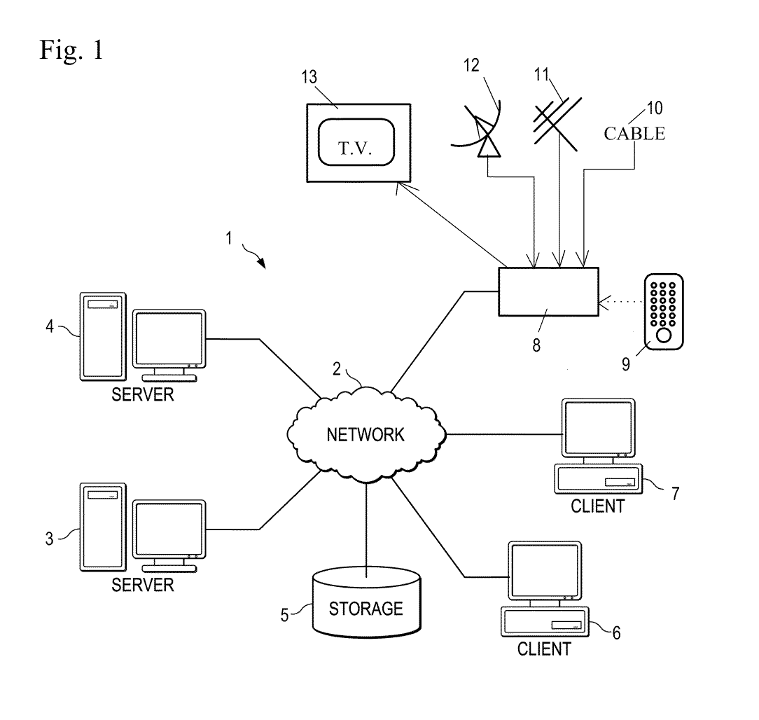

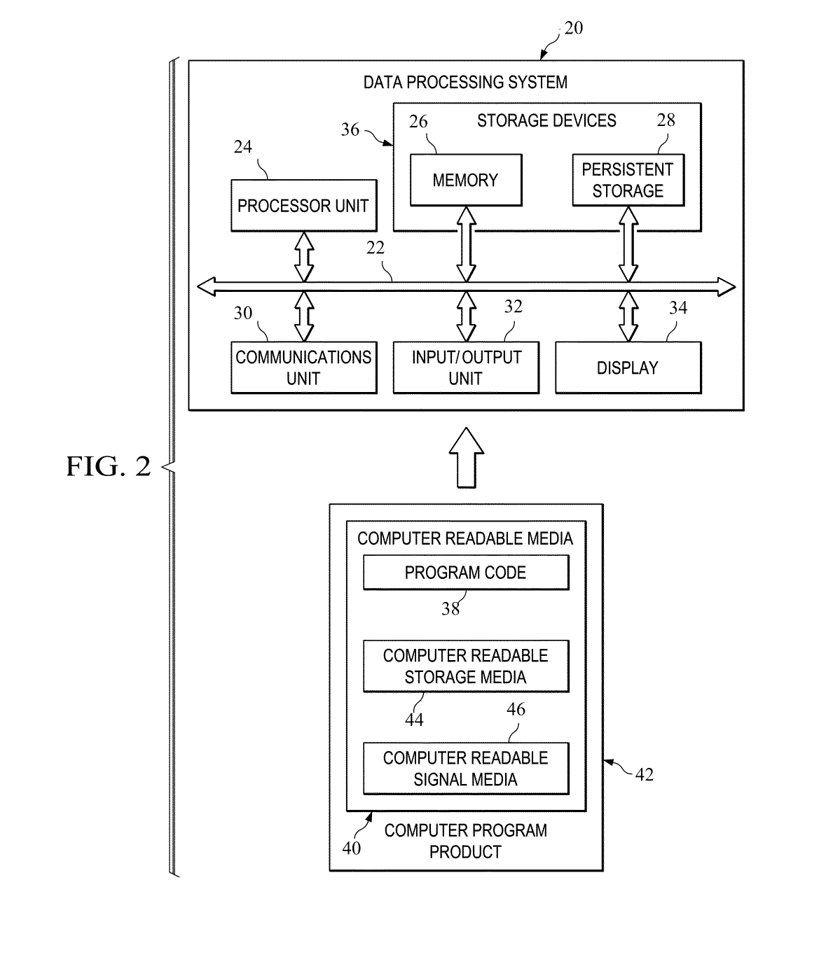

With reference now to the figures, and in particular, with reference to FIGS. 1 and 2, exemplary diagrams of data processing environments are provided in which illustrative embodiments may be implemented. It should be appreciated that FIGS. 1 and 2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 1 is a network of computers in which the illustrative embodiments may be implemented. Network data processing system 1 contains network 2, which is the medium used to provide communication links between various devices and computers connected together within network data processing system 1. Network 2 may include connections, such as wire, wireless communication links, or fiber optic cables.

In the depicted example, server 3 and server 4 connect to network 2 along with storage unit 5. In addition, clients 6, 7, and 8 connect to network 2. Clients 6 and 7 may be, for example, personal computers, network computers, or other portable devices. Client 8 may be, for example a digital video recorder which may be connected to cable 10, a television antenna 11, and/or satellite 12 to receive a signal that is displayed on a television (T.V.) 13 connected to the client 8. A universal remote 9 may be used to interact with the client 8. The other clients 6 and 7 may also be used to interact with the client 8. In the depicted example, server 3 provides information, such as boot files, operating system images, and applications to clients 6, 7, and 8. Clients 6, 7, and 8 are clients to server 3 in this example. Network data processing system 1 may include additional servers, clients, and other devices not shown.

Program code or television broadcasts located in network data processing system 1 may be stored on a computer recordable storage medium and downloaded to a data processing system or other device for use. For example, program code may be stored on a computer recordable storage medium on server 4 and downloaded to client 8 over network 2 for use on client 8.

In the depicted example, network data processing system 1 is the a local area network (LAN) with network 2 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 1 also may be implemented as a number of different types of networks, such as, for example, an intranet, Internet, or a wide area network (WAN). FIG. 1 is intended as an example, and not as an architectural limitation, for the different illustrative embodiments.

With reference now to FIG. 2, a block diagram of a data processing system is shown in which illustrative embodiments may be implemented. Data processing system 20 is an example of a computer, such as server 3 or client 8 in FIG. 1, in which computer usable program code or instructions implementing the processes may be located for the illustrative embodiments. In this illustrative example, data processing system 20 includes communications fabric 22, which provides communications between processor unit 24, memory 26, persistent storage 28, communications unit 30, input/output (I/O) unit 32, and display 34.

Processor unit 24 serves to execute instructions for software that may be loaded into memory 26. Processor unit 24 may be a set of one or more processors, or may be a multi-processor core, depending on the particular implementation. Further, processor unit 24 may be implemented using one or more heterogeneous processor systems in which a main processor is present with secondary processors on a single chip. As another illustrative example, processor unit 24 may be a symmetric multi-processor system containing multiple processors of the same type.

Memory 26 and persistent storage 28 are examples of storage devices 36. A storage device is any piece of hardware that is capable of storing information, such as, for example, without limitation, data, program code in functional form, and/or other suitable information either on a temporary basis and/or a permanent basis. Memory 26, in these examples, may be, for example, a random access memory or any other suitable volatile or non-volatile storage device. Persistent storage 28 may take various forms depending on the particular implementation. For example, persistent storage 28 may contain one or more components or devices. For example, persistent storage 28 may be a hard drive, a flash memory, a rewritable optical disk, a rewritable magnetic tape, or some combination of the above. The media used by persistent storage 28 also may be removable. For example, a removable hard drive may be used for persistent storage 28.

Communications unit 30, in these examples, provides for communications with other data processing systems or devices. In these examples, communications unit 30 is a network interface card. Communications unit 30 may provide communications through the use of either or both physical and wireless communication links.

Input/output unit 32 allows for input and output of data with other devices that may be connected to data processing system 20. For example, input/output unit 32 may provide a connection for user input through a keyboard, a mouse, and/or some other suitable input device. Further, input/output unit 32 may send output to a printer. Display 34 provides a mechanism to display information to a user.

Instructions for the operating system, applications, and/or programs may be located in storage devices 36, which are in communication with processor unit 24 through communications fabric 22. In these illustrative examples the instructions are in a functional form on persistent storage 28. These instructions may be loaded into memory 26 for running by processor unit 24. The processes of the different embodiments may be performed by processor unit 24 using computer implemented instructions, which may be located in a memory, such as memory 26.

These instructions are referred to as program code, computer usable program code, or computer readable program code, that may be read and run by a processor in processor unit 24. The program code in the different embodiments may be embodied on different physical or tangible computer readable media, such as memory 26 or persistent storage 28.

Program code 38 is located in a functional form on computer readable media 40 that is selectively removable and may be loaded onto or transferred to data processing system 20 for running by processor unit 24. Program code 38 and computer readable media 40 form computer program product 42 in these examples. In one example, computer readable media 40 may be in a tangible form, such as, for example, an optical or magnetic disc that is inserted or placed into a drive or other device that is part of persistent storage 28 for transfer onto a storage device, such as a hard drive that is part of persistent storage 28. In a tangible form, computer readable media 40 also may take the form of a persistent storage, such as a hard drive, a thumb drive, or a flash memory that is connected to data processing system 20. The tangible form of computer readable media 40 is also referred to as computer recordable storage media. In some instances, computer readable media 40 may not be removable.

Alternatively, program code 38 may be transferred to data processing system 20 from computer readable media 40 through a communications link to communications unit 30 and/or through a connection to input/output unit 32. The communications link and/or the connection may be physical or wireless in the illustrative examples. The computer readable media also may take the form of non-tangible media, such as communication links or wireless transmissions containing the program code.

In some illustrative embodiments, program code 38 may be downloaded over a network to persistent storage 28 from another device or data processing system for use within data processing system 20. For instance, program code stored in a computer readable storage medium in a server data processing system may be downloaded over a network from the server to data processing system 20. The data processing system providing program code 38 may be a server computer, a client computer, or some other device capable of storing and transmitting program code 38.

The different components illustrated for data processing system 20 are not meant to provide architectural limitations to the manner in which different embodiments may be implemented. The different illustrative embodiments may be implemented in a data processing system including components in addition to, or in place of, those illustrated for data processing system 20. Other components shown in FIG. 2 can be varied from the illustrative examples shown. The different embodiments may be implemented using any hardware device or system capable of executing program code. As one example, the data processing system may include organic components integrated with inorganic components and/or may be comprised entirely of organic components excluding a human being. For example, a storage device may be comprised of an organic semiconductor.

As another example, a storage device in data processing system 20 is any hardware apparatus that may store data. Memory 26, persistent storage 28 and computer readable media 40 are examples of storage devices in a tangible form.

In another example, a bus system may be used to implement communications fabric 22 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 26 or a cache such as found in an interface and memory controller hub that may be present in communications fabric 22.

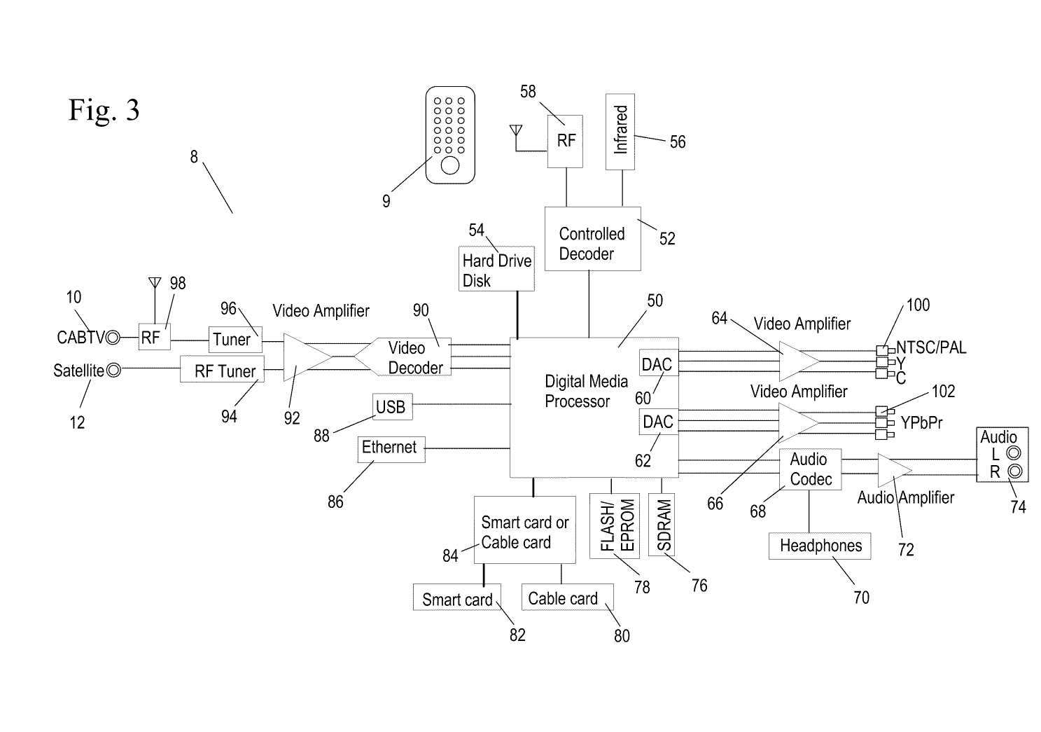

FIG. 3 shows an exemplary diagram of video recorder, in particular a digital video recorder (DVR) 8 provided in which illustrative embodiments may be implemented. It should be appreciated that FIG. 3 is only exemplary and is not intended to assert or imply any limitation with regard to different embodiments which may be implemented. Modifications to the video recorder may be made.

The video recorder 8 has a digital media processor 50 with at least one digital-to-analog converter 60 which is connected to a video amplifier 64 and has inputs 100 for phase alternate line (PAL)/National Television System Committee (NTSC), composite video Y (luminance) and C (chrominance). A second digital-to-analog converter 60 is preferably present in the digital media processor 50 and is connected to a video amplifier 66 and has inputs 102 for YPbPr or component video.

The digital media processor 50 is also connected to an audio codec 68 for encoding analog audio as digital signals and vice versa. The audio codec 68 is connected to headphones 70 and an audio amplifier 72 for audio left L and right R outputs 74.

The video recorder 8 also hard drive disk or storage 54 as well as flash or erasable programmable read only memory (EPROM) and synchronous dynamic random access memory (SDRAM) enabling a user to store TV broadcasts of their choosing.

An input 84 for a smart card 82 or cable card 80 may be present with the DVR 8 for users who need to decode an encrypted digital cable signal without using a set-top box.

The video recorder 8 has at least one tuner 96, and preferably has at least two tuners 94, 96. Tuner 96 is connected to an input for cable television 10 or to receive a broadcast signal through a radio frequency (RF) antenna 98. Tuner 96 is connected to a video amplifier 92, which in turn is connected to a video decoder 90 that sends a signal to the digital media processor 50. The second tuner 94 is connected to an input 12 for satellite and the video amplifier 92. From the video amplifier 92, a signal goes through a video decoder 90 and is then sent to the digital media processor 50. The digital media processor 50 has a port to connect to the Ethernet 86 or to another device through a universal serial bus (USB) port 88.

The digital media processor 50 of the video recorder 8 may be controlled by a universal remote 9 that communicates with a controlled decoder 52 coupled to the digital media processor 50 through infrared 56 or radio frequency (RF) signals 58.

The present invention is a method and system that enhances video recorder's functionality by creating a branch of an original show for playback on a secondary viewing device such as an alternate television set, handheld device, or computer while not interfering with primary viewing on a display or primary viewing device coupled to the video recorder.

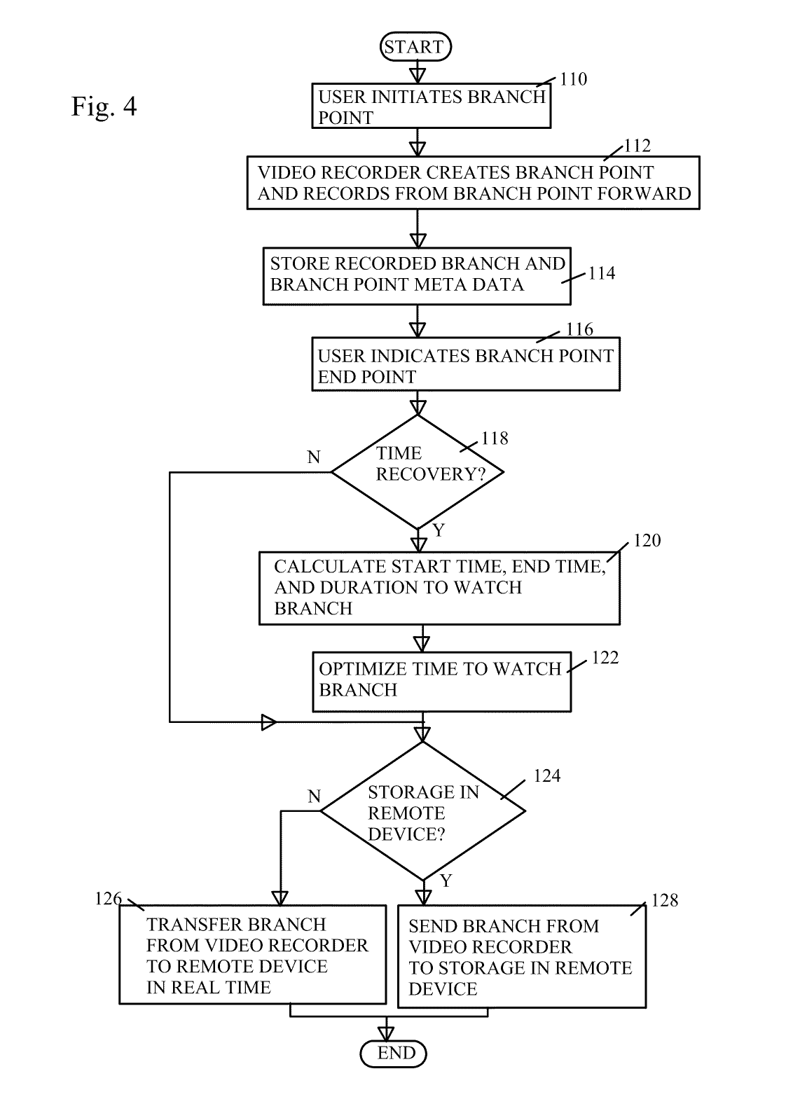

FIG. 4 shows a block diagram of the steps for inserting a branch point in a program using a video recorder on a primary viewing device such as a television or monitor and watching a program or broadcast from the branch point on an alternate secondary viewing device from the primary viewing device. A digital video recorder as shown in FIG. 3 may be used.

A user initiates a branch point in a program using an interface on the video recorder (step 110). A branch point is a point in the program or broadcast in which a branch instruction is given. The branch is the portion of the program that records from the branch point onwards. The initiation of the branch point may be created manually by the user initiating the action for example through the remote control or some other interface. The branch point may also be initiated by the user scheduling a branch point to occur later in time, for example in 5 minutes through an interface on the video recorder. The video recorder then creates the branch point and records the program from the branch point forward in step 112. Once the branch point is created in step 112, the DVR stores meta-data along with the branch point recording (step 114), so that the branch point or branch may be searched, located, and/or manipulated at a later time. The branch point meta-data preferably includes information such as user identification and a time stamp. Once the user returns or indicates that they want the branch point to end (step 116), recording of the program ends.

After the user indicates the branch point end point, the user has an option of whether to use time recovery (step 118). Time recovery plays back key portions of the branch to get the user back to the current program position in the least amount of time. Since the video recorder knows the start, end, and duration of the branch point, the time it takes to traverse the branch and return the original program may be minimized.

For example, if the branch recorded is 2 minutes in length, it will take 2 additional minutes of time to traverse the branch and return to the current place in the program. A user watching the branch could never return to or catch up to the current program without either skipping forward on the branch or pausing the playback of the current program. Time recovery allows the user to watch the branch and return to the current playing of the original program. If the branch contained commercials, the video recorder may detect the commercials and skip over them, decreasing the amount of time it would take to watch the branch. Additionally, in certain programs such as sports casting, replays of specific scenes in the program occurs with some frequency and may be skipped within the branch. The replays may be tagged with meta-data from the broadcaster or replay recognition to detect a replay based on video analysis. By skipping over the replays, the branch time would be decreased.

If the user chooses to use time recovery (step 118), then the start time, end time and duration to watch the branch is calculated by the video recorder in step 120. Then, the video recorder optimizes the time to watch the branch to allow the user to “catch up” or be able to watch the program in its current playing or time frame in step 122. In other words, minimize the time necessary to complete display of the branch. The optimization of the time to watch the branch may skip over commercials or replays as discussed above.

After the branch point has been optimized in step 122, a secondary viewing device in which the user(s) watches or displays the branch on is analyzed by the video recorder for the presence of storage (step 124). The secondary viewing device is preferably remote from the primary viewing device and video recorder. If no storage or very little storage is present, the branch is transferred or streamed to the secondary viewing device from the storage device of the video recorder for the user(s) to watch in step 126. If storage is present, the branch is sent to and stored in the storage of the secondary viewing device (step 128).

The methods used to send a branch to a video recorder with storage and without storage (step 126, 128) may be a wired transmission using a method such as Ethernet, wireless transmission using such a method as wireless Ethernet, or accessing a local network

The secondary viewing device is preferably a device including a screen capable of playing video, speakers or a headphone jack, network capability and storage (volatile or persistent). The secondary view device may be for example client 7 or client 8 as shown in FIG. 1. If the secondary viewing device does contain volatile storage, the storage is preferably of sufficient size to contain a duration of programming or at least one branch. The secondary viewing device preferably enables a user(s) to retrieve the branch from the video recorder for playback, control of the playback, and deletion of the branch.

By sending the branch to a secondary viewing device, any user(s) currently viewing a program in real time are not disturbed and a user(s) who missed part of the program can still watch the program and return to watching the current program in real time.

If the user(s) does not want to use time recovery (step 118), the secondary viewing device in which the user(s) views the branch on is analyzed by the video recorder for storage (step 124). If no storage or very little storage is present, the branch is transferred or streamed to the secondary viewing device from the storage device of the video recorder for the user(s) to watch in step 126. If storage is present, the branch is sent to and stored in the storage of the secondary viewing device (step 128).

For example, the method of setting and watching a branch point as shown in FIG. 4 may be employed in the following situation. A group of friends is watching a football game. One user leaves the room to get food and drink for the other users and requests a branch point. The video recorder creates the branch point. The video recorder stores the program and branch point meta-data and records the program from the branch point forward. The remaining users continue to watch the football game. While the user was gone, a touchdown occurred. When the user gets back to the room, the user indicates an end point for the branch point. So as not to disturb the other users watching the game, the user indicates that they wish to employ time recovery and the video recorder calculates the start time, end time and duration to watch the branch. Then the video recorder optimizes the time to watch the branch, preferably by removing commercials and replays of the plays. Then, a secondary viewing device with storage is sent the branch for viewing. The user views the branch on the secondary viewing device and is now able to continue watching the football game with the rest of the users on the primary display.

The instant playback is preferably of the same show being viewed in the primary viewing by another user.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present invention may be written in an object oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims.

What is claimed is:

1. A method for recording a branch of a program being viewed on a primary viewing device coupled to a video recorder having a computer and a computer readable storage media, and for playback of the branch on a secondary viewing device comprising:
creating, by a processor of the computer, a branch point in a program on receiving an input from a user;
recording and storing, by a processor of the computer, a branch of the program from the branch point onward in the computer readable storage media; and
sending the recorded branch to the secondary viewing device for viewing.

2. The method of claim 1, wherein the creating of a branch point in a program is responsive to receiving a signal through an interface of the video recorder.

3. The method of claim 1, wherein storing the recorded branch in the computer readable storage media further comprises storing meta-data of the branch point in the computer readable storage media.

4. The method of claim 3, wherein the meta-data of the branch point in the computer readable storage media is searchable, by a processor of the computer, through an interface of the video recorder.

5. The method of claim 3, wherein the meta-data of the branch point in the computer readable storage includes a user identification and a time stamp.

6. The method of claim 1, wherein prior to sending the recorded branch to the secondary viewing device for viewing, the secondary viewing device is analyzed, by a processor of the computer, for its storage capabilities.

7. The method of claim 1, further comprising displaying the branch on a secondary viewing device.

8. The method of claim 7, wherein the branch is displayed on the secondary viewing device as it is being streamed from the computer readable storage media of the video recorder.

9. The method of claim 1, wherein before storing the recorded branch in the readable storage media, an end point of the branch is responsive to receiving a signal through an interface of the video recorder.

10. The method of claim 1, wherein prior to sending the recorded branch to the secondary viewing device for viewing, the method further comprises: calculating, by a processor of the computer, a start time, end time, and duration to watch the recorded branch on the secondary viewing device, wherein the time to watch the branch is minimized by skipping over specific segments in the recorded branch.

11. The method of claim 10, wherein the specific segments are commercials.

12. The method of claim 10, wherein the specific segments are replays of segments already present in the branch.

13. The method of claim 1, wherein the secondary viewing device is remote from the primary viewing device.

14. The method of claim 1, wherein the secondary viewing device is an alternate television set, a handheld device, or a computer.

15. A system of for recording a branch of a program comprising:
a video recorder comprising a computer and a computer readable storage media
a secondary viewing device in communication with the video recorder for displaying a recorded branch to the user;
first program instructions to create a branch point in a program responsive to receiving a signal through an interface of the video recorder,
second program instructions to record the branch of the program from the branch point onward and storing the recorded branch of the program in the computer readable storage media; and
third program instructions to send the recorded branch of the program to the secondary viewing device;
wherein the first, second, and third program instructions are stored on the computer readable storage media.

16. The system of claim 15, wherein the first program instructions to create the branch point in a program is responsive to receiving a signal through an interface in the video recorder.

17. The system of claim 15, wherein the second program instructions further comprises storing meta-data of the branch point in the computer readable storage media.

18. The system of claim 17, wherein the meta-data of the branch point in the computer readable storage media is searchable through an interface of the video recorder and includes a user identification and a time stamp.

19. The system of claim 15, wherein the branch is displayed on the secondary viewing device as it is being streamed from the computer readable storage media of the video recorder.

20. The system of claim 15, wherein the secondary viewing device is an alternate television set, a handheld device, or a computer.
